(19) United States
(12) Patent Application Publication
(10) Pub. No.: US 2022/0148066 A1
(43) Pub. Date: May 12, 2022

(54) CONTENT PROVIDING DEVICE, RECOMMENDED CONTENT PRESENTING METHOD, AND RECORDING MEDIUM

(71) Applicant: Rakuten Group, Inc., Tokyo (JP)

(72) Inventors: Robert GAUL, Tokyo (JP); Ashley ZATTELMAN, Tokyo (JP); Brendan PAULL, Tokyo (JP); Tomoko YAMADA, Tokyo (JP)

(73) Assignee: Rakuten Group, Inc., Tokyo (JP)

(21) Appl. No.: 17/515,787

(22) Filed: Nov. 1, 2021

(30) Foreign Application Priority Data
Nov. 6, 2020 (JP) 2020-185696

(51) Int. Cl. G06Q 30/06; G06F 3/14

(52) U.S. Cl. CPC G06Q 30/0631; G06F 3/14

(57) ABSTRACT

A storage stores content sets in which, when a preceding content is used, a subsequent content is made available after a lapse of certain time. A provider provides, to a user terminal, an available content that is usable by a user among contents within the content sets. A setter sets, when an unused content not having been used by the user among the available contents is first used, a start date and time at which a subsequent content following after the unused content is made available, in association with the subsequent content. A selector selects, according to time remaining until the set start date and time, at least one recommended content from among the available contents. A generator generates a recommendation list in which the selected recommended content is followed by the subsequent content. A presenter presents the generated recommendation list to the user terminal.

### CROSS-REFERENCE TO RELATED APPLICATION

This application claims the benefit of Japanese Patent Application No. 2020-185696, filed on Nov. 6, 2020, the entire disclosure of which is incorporated by reference herein.

### FIELD

The present disclosure relates to a content providing device, a recommended content presenting method, and a recording medium.

### BACKGROUND

In recent years, e-books are widely used. For example, a user can freely read an e-book purchased or the like, by using a user terminal such as a dedicated e-book reader or a smartphone.

As a related art for e-books, for example, Japanese Patent No. 5564635 discloses an invention of an e-book system preferable for increasing purchase motivation of a user.

In the above-described e-book system providing e-books, for example, a user can use (read or the like) some e-books for free for promotional purposes. By taking advantage of free e-books, many users check usability of e-books using a user terminal, a content of an e-book, and the like. As a result, purchase of a subsequent e-book or a relevant e-book is promoted.

In recent e-book systems, an e-book such as a comic is managed in units of one chapter when provided for free. For example, in an e-book system, only a first chapter (Chapter 1) of a certain comic e-book is available at first. When the first chapter is used by a user, the e-book system makes a second chapter (Chapter 2) of the same e-book available to the user after a lapse of certain time (as one example, twenty-three hours). Similarly, thereafter, when a preceding chapter (Chapter 2 or the like) is used by the user, the e-book system makes a subsequent chapter (Chapter 3 or the like) available to the user after a lapse of certain time.

In this way, in an e-book system, a free e-book is made available to a user at time intervals in units of one chapter. For example, a user accesses an e-book system from a user terminal to use an e-book in daily spare time (as one example, during a travel by train or bus, during a break at school or work, before bedtime, and the like) in a user's own life. Consequently, use of an e-book can be also expected to become a habit of a user. Further, each user tends to have spare time in almost a same time zone. Thus, a user having used a preceding chapter in spare time on a previous day can use a subsequent chapter in spare time (a same time zone) on a following day.

Many users have more time to spare on a holiday or the like compared with a weekday. Thus, in some cases, a user may access an e-book system from a user terminal a few hours earlier than a time zone of normal use time. In this case, a subsequent chapter following after a preceding chapter used on a previous day is not available yet. As a result, the user gives up use of an e-book and withdraws from the e-book system to spend time for other things.

Such withdrawal from an e-book system in this way is undesired and may be a trigger for a user to stop daily use of an e-book. Thus, it has been desired to prevent withdrawal from an e-book system by allowing a user to use another e-book until time when a subsequent chapter is made available.

Such a problem applies not only to an e-book system providing e-books, but also to many systems providing various types of contents including movies and games. Thus, a technique for allowing a user to use another content until time when a content is made available has been desired for a system providing contents.

### SUMMARY

The present disclosure has been made in view of the above circumstance, and an objective of the present disclosure is to provide a content providing device, a recommended content presenting method, and a recording medium that can appropriately select and present a recommended content according to time remaining until a content is made available.

A content providing device according to a first point of view of the present disclosure includes:

a storage to store a plurality of content sets including a plurality of contents to be used in defined order, in which, when a preceding content is used, a subsequent content is made available after a lapse of certain time;

a provider to provide, to a user terminal, an available content that is usable by a user among contents within a plurality of the content sets stored in the storage;

a setter to set, when an unused content not having been used by the user among the available contents provided to the user terminal is first used, a start date and time at which a subsequent content following after the unused content is made available, in association with the subsequent content;

a selector to select, according to time remaining until the start date and time set by the setter, at least one recommended content from among the available contents provided to the user terminal;

a generator to generate a recommendation list in which the recommended content selected by the selector is followed by the subsequent content; and

a presenter to present the recommendation list generated by the generator to the user terminal.

Further, in the content providing device according to the above point of view,

the provider may provide, to the user terminal, the associated subsequent content as the new available content when the start date and time set by the setter comes.

Further, the content providing device according to the above point of view further includes a specifier specifying the unused content among the available contents from the another content set relevant to the content set to which the subsequent content belongs, in which

the selector may select, as the recommended content, the unused content specified by the specifier.

Further, the content providing device according to the above point of view further includes an estimator estimating required time to be spent when the user uses the unused content specified by the specifier, in which

the selector may repeat selection of the recommended content while specification of the unused content by the specifier and estimation of the required time by the estimator are continued, until the accumulated required time estimated by the estimator becomes equal to or more than the remaining time.

Further, in the content providing device according to the above point of view,

the provider may provide, to the user terminal, the subsequent content as the new available content when the user uses the recommended content in order based on the recommendation list and a time difference between a date and time at which the user, even before the start date and time, comes to use the subsequent content and the start date and time is within a reference.

Further, in the content providing device according to the above point of view,

the selector may re-select, according to the time remaining from a current point in time to the start date and time, the recommended content when predetermined time elapses with the recommended content based on the recommendation list remaining unused by the user after the recommendation list is presented to the user terminal,

the generator may re-generate the recommendation list in which the recommended content re-selected by the selector is followed by the subsequent content, and

the presenter may re-present the recommendation list re-generated by the generator to the user terminal.

A recommended content presenting method according to a second point of view of the present disclosure is executed by a content providing device that includes a storage storing a plurality of content sets including a plurality of contents to be used in defined order, in which, when a preceding content is used, a subsequent content is made available after a lapse of certain time, and the recommended content presenting method includes:

providing, to a user terminal, an available content that is usable by a user among contents within a plurality of the content sets stored in the storage;

setting, when an unused content not having been used by the user among the available contents provided to the user terminal is first used, a start date and time at which a subsequent content following after the unused content is made available, in association with the subsequent content;

selecting, according to time remaining until the set start date and time, at least one recommended content from among the available contents provided to the user terminal;

generating a recommendation list in which the selected at least one recommended content is followed by the subsequent content; and

presenting the generated recommendation list to the user terminal.

A recording medium according to a third point of view of the present disclosure is a non-transitory computer-readable recording medium on which a program is recorded for causing a computer that includes a storage storing a plurality of content sets including a plurality of contents to be used in defined order, in which, when a preceding content is used, a subsequent content is made available after a lapse of certain time to function as:

a provider to provide, to a user terminal, an available content that is usable by a user among contents within a plurality of the content sets stored in the storage;

a setter to set, when an unused content not having been used by the user among the available contents provided to the user terminal is first used, a start date and time at which a subsequent content following after the unused content is made available, in association with the subsequent content;

a selector to select, according to time remaining until the start date and time set by the setter, at least one recommended content from among the available contents provided to the user terminal;

a generator to generate a recommendation list in which the recommended content selected by the selector is followed by the subsequent content; and

a presenter to present the recommendation list generated by the generator to the user terminal.

The above recording medium is a non-transitory recording medium and can be distributed and sold independently of a computer. Herein, the non-transitory recording medium indicates a tangible recording medium. The non-transitory recording medium is, for example, a compact disc, a flexible disk, a hard disk, a magneto-optical disk, a digital video disc, a magnetic tape, a semiconductor memory, and the like. Further, a transitory recording medium indicates a transmission medium (a propagation signal) per se. The transitory recording medium is, for example, an electrical signal, an optical signal, an electromagnetic wave, and the like. Note that, a temporary storage area is an area for temporarily storing data or a program, and is a volatile memory such as, for example, a random access memory (RAM).

According to the present disclosure, a recommended content can be appropriately selected and presented according to time remaining until a content is made available.

### BRIEF DESCRIPTION OF THE DRAWINGS

A more complete understanding of this application can be obtained when the following detailed description is considered in conjunction with the following drawings, in which:

FIG. 1 is a block diagram illustrating one example of an overall configuration of a content providing system according to the present embodiment;

FIG. 2 is a block diagram illustrating one example of a schematic configuration of a typical information processing device for achieving a content providing device and a user terminal;

FIG. 3 is a block diagram illustrating one example of a function configuration of a content providing device according to the present embodiment;

FIG. 4 is a schematic diagram illustrating one example of content management information;

FIG. 5 is a schematic diagram illustrating one example of a recommendation list;

FIG. 6 is a block diagram illustrating one example of a function configuration of a user terminal according to the present embodiment;

FIG. 7 is a schematic diagram illustrating one example of a recommendation list displayed on the user terminal;

FIG. 8 is a flowchart for describing use management processing according to the present embodiment; and

FIG. 9 is a flowchart for describing recommendation presentation processing according to the present embodiment.

### DETAILED DESCRIPTION

Hereinafter, an embodiment of the present disclosure will be described. In the embodiment of the present disclosure, a content providing system providing e-books will be described as one example. However, as will be described later, the present disclosure is also applicable to, for example, a content providing system providing other contents including movies and games, without limitation to e-books.

In other words, the following embodiment is for illustrative purposes, but is not for limiting the scope of the present disclosure. Accordingly, a person skilled in the art is capable of employing embodiments in which each element or all elements thereof are replaced with equivalents thereof, but these embodiments are also included in the scope of the present disclosure.

Overall Configuration

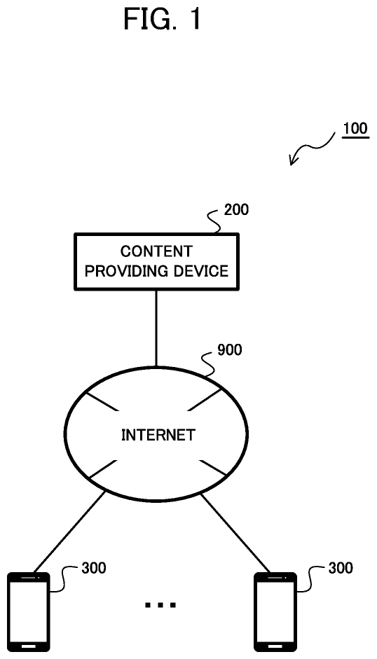

As illustrated in FIG. 1, a content providing system 100 according to the embodiment of the present disclosure includes a content providing device 200 providing e-books, a user terminal 300 for use by a user, and an internet 900 via which the content providing device 200 and the user terminal 300 are connected with each other. Note that, although being simplified in the figure, a large number of user terminals 300 exist depending on the number of users who use the system.

The content providing device 200 manages various types of e-books (as one example, comics, novels, practical books, photo books, and the like) including free e-books, and provides a free e-book or an e-book purchased by a user to the user terminal 300.

As will be described later, when providing an e-book such as a comic for free, the content providing device 200 manages the e-book in such a way that a user can use the e-book at certain time intervals in units of one chapter.

The user terminal 300 is, for example, a smartphone, a tablet terminal, and the like, with an e-book app and the like installed thereon. Note that, the user terminal 300 may be a dedicated e-book reader.

A user who uses the user terminal 300 activates (executes), for example, an e-book app to access the content providing device 200. Then, the user reads an e-book made available by purchase or the like. In particular, in a case of an e-book such as a comic provided for free, the e-book is managed as appropriate by the content providing device 200 in units of one chapter, and, when a preceding chapter is used by a user, a subsequent chapter is made available to the user after a lapse of certain time.

Note that, a user may use such an e-book by activating a browser (a browser app) installed on the user terminal 300 to access the content providing device 200.

Schematic Configuration of Information Processing Device

A typical information processing device 400 for achieving the content providing device 200 and the user terminal 300 according to the embodiment of the present disclosure will be described.

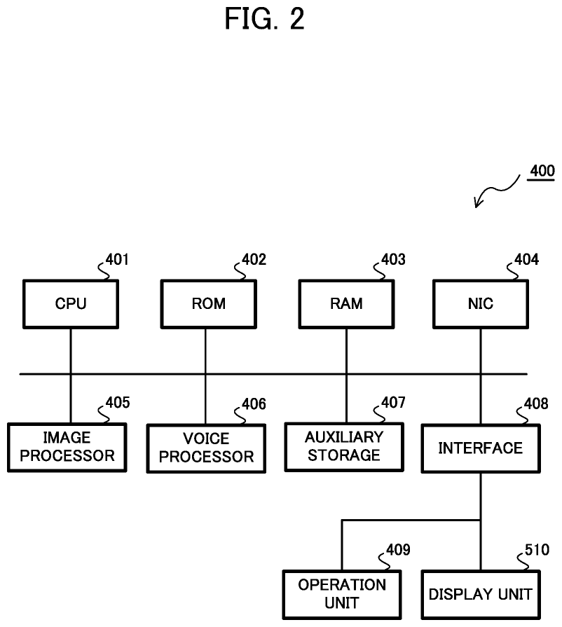

As illustrated in FIG. 2, the information processing device 400 includes a central processing unit (CPU) 401, a read-only memory (ROM) 402, a random access memory (RAM) 403, a network interface card (NIC) 404, an image processor 405, a voice processor 406, an auxiliary storage 407, an interface 408, an operation unit 409, and a display unit 410.

The CPU 401 controls operation of the entire information processing device 400. The CPU 401 is connected with each component to exchange a control signal or data therebetween.

On the ROM 402, an initial program loader (IPL) to be executed immediately after power-on is recorded. When the IPL is executed, a program stored in the auxiliary storage 407 is read into the RAM 403 and execution of the program by the CPU 401 is started.

The RAM 403 is for temporarily storing data or a program. A program or data read out from the auxiliary storage 407 and other data or the like necessary for communication are stored in the RAM 403.

The NIC 404 is for connecting the information processing device 400 to a computer communication network such as the Internet. The NIC 404 includes an NIC conforming to a 10BASE-T/100BASE-T standard for use in configuring a local area network (LAN), an analog modem for connecting to the Internet by using a telephone line, an integrated services digital network (ISDN) modem, an asymmetric digital subscriber line (ADSL) modem, a cable modem for connecting to the Internet by using a cable television line, and the like.

The image processor 405 processes, by using an image calculation processor (not illustrated) included in the CPU 401 or the image processor 405, image data read out from the auxiliary storage 407 or the like, and thereafter records the image data in a frame memory (not illustrated) included in the image processor 405. Image information recorded in the frame memory is converted into a video signal at predetermined synchronization timing, and the video signal is output to the outside via the interface 408 or the like. Note that, when the information processing device 400 internally includes a display device, the image processor 405 outputs the converted video signal to the display device. In other words, the image processor 405 generates, under control of the CPU 401, an image that is needed in the course of processing performed by the information processing device 400, and causes an internal or external display device to display the image.

The voice processor 406 converts music data or voice data read out from the auxiliary storage 407 or the like into a voice signal, and outputs the voice signal to the outside via the interface 408 or the like. Note that, when the information processing device 400 internally includes a speaker, the voice processor 406 outputs the converted voice signal to the speaker. In other words, the voice processor 406 generates, under control of the CPU 401, a music sound or a voice that has to be produced in the course of processing performed by the information processing device 400, and causes an internal or external speaker to output the music sound or the like.

The auxiliary storage 407 is a hard disk, a solid state drive (SSD), and the like. The auxiliary storage 407 stores various types of programs or various types of data necessary for operation control of the entire information processing device 400. For example, the auxiliary storage 407 stores a program for achieving the content providing device 200 and the like according to the embodiment. Then, the auxiliary storage 407 reads out, by control of the CPU 401, the stored programs or data as appropriate, and causes the RAM 403 or the like to temporarily store the programs or data.

The interface 408 conforms to a standard such as, for example, HDMI (registered trademark) and a universal serial bus (USB). The operation unit 409 and the display unit 410 are connected with the interface 408. Note that, the interface 408 transmits and receives necessary information to and from other external equipment connected therewith.

The operation unit 409 accepts an operation input by an operator or the like who uses the information processing device 400.

The display unit 410 draws an image corresponding to image data output by the image processor 405, and presents the image to an operator or the like who uses the information processing device 400.

Beside the above, the information processing device 400 may include a drive unit such as a digital versatile disc (DVD)-ROM, instead of the auxiliary storage 407. In this case, the information processing device 400 operates similarly to the above by reading out a program or data from a DVD-ROM installed on a drive unit.

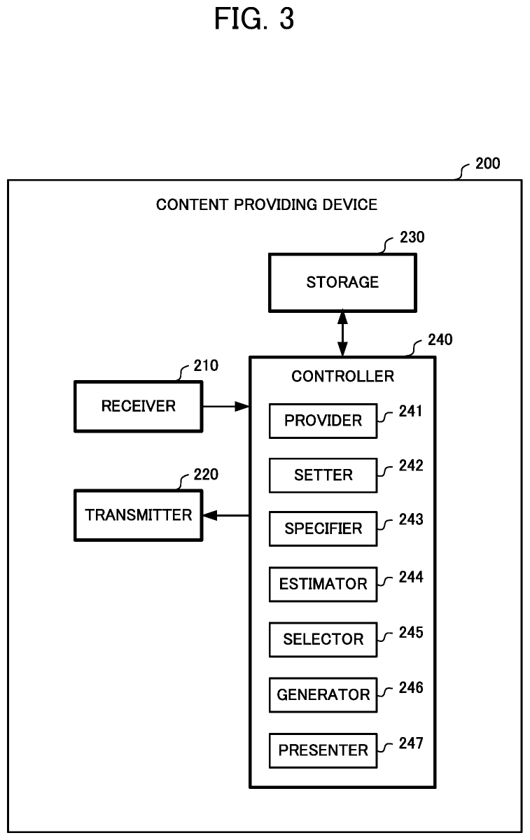

Hereinafter, a function configuration or the like of the content providing device 200 achieved by the above information processing device 400 will be described with reference to FIGS. 3 to 5. When the information processing device 400 is powered on and is made communicable with, for example, the user terminal 300, a program for causing to function as the content providing device 200 according to the present embodiment is executed, and the content providing device 200 according to the present embodiment is achieved.

The user terminal 300 to be described later is also achieved by the information processing device 400, similarly.

Function Configuration of Content Providing Device 200

FIG. 3 is a block diagram illustrating one example of a function configuration of the content providing device 200 according to the present embodiment. As illustrated, the content providing device 200 includes a receiver 210, a transmitter 220, a storage 230, and a controller 240.

The receiver 210 receives information sent from the user terminal 300 via the internet 900.

For example, the receiver 210 receives an instruction to purchase an e-book, an instruction to read an e-book made available, and the like sent from the user terminal 300.

The above-described NIC 404 may function as the receiver 210 like the above.

The transmitter 220 transmits necessary information to the user terminal 300 or the like via the internet 900.

For example, the transmitter 220 transmits, to the user terminal 300, actual data of an e-book made available by purchase or the like. In a case of an e-book such as a comic provided for free, since the e-book is managed in units of one chapter, the transmitter 220 transmits an available chapter (one chapter made available) to the user terminal 300.

Further, as will be described later, the transmitter 220 transmits, to the user terminal 300, a recommendation list generated by the controller 240 (a generator 246).

The above-described NIC 404 may function as the transmitter 220 like the above.

The storage 230 stores, for example, content management information for managing an e-book that can be used by a user (including an e-book that can be used in the future as well).

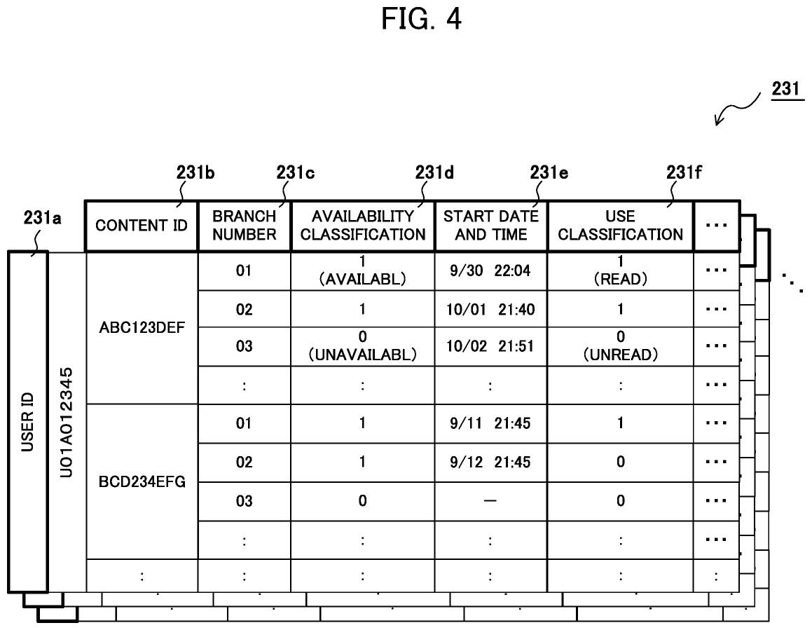

For example, the storage 230 stores content management information 231 as illustrated in FIG. 4.

As illustrated in FIG. 4, the content management information 231 includes, as one example, a user ID 231a, a content ID 231b, a branch number 231c, an availability classification 231d, a start date and time 231e, and a use classification 231f.

Note that, the content ID 231b is information for identifying an e-book. Further, the branch number 231c is information for identifying each chapter in an e-book. Further, the availability classification 231d indicates whether an entire e-book or each chapter in an e-book is available (1: available) or unavailable (0: unavailable).

Further, the start date and time 231e indicates a date and time at which an entire e-book or each chapter in an e-book is made available. In a case of an e-book such as a comic provided for free, when a preceding chapter is used by a user, a date and time after a lapse of certain time (as one example, twenty-three hours later) is set in the start date and time 231e associated with a subsequent chapter. Further, the use classification 231f indicates whether an entire e-book or each chapter in an e-book is used (1: read) or not used (0: unread).

Besides the above, the storage 230 also stores user information (a user ID, a password, an address, an age, payment card information, and the like) of each user, management information (a content ID, a book title, an author name, a genre, and the like) of each e-book, and actual data of each e-book.

Note that, the above-described auxiliary storage 407 or the like may function as the storage 230 like the above.

Returning to FIG. 3, the controller 240 controls the entire content providing device 200.

The controller 240 includes, for example, a provider 241, a setter 242, a specifier 243, an estimator 244, a selector 245, a generator 246, and a presenter 247.

The provider 241 provides, by controlling the transmitter 220, an e-book that can be used by a user to the user terminal 300. Note that, in a case of an e-book such as a comic provided for free, the provider 241 provides, to the user terminal 300, an available chapter (an available content) that can be used by a user among chapters within the e-book.

The setter 242 sets, when an unread chapter (an unused content) not having been used by a user among available chapters provided to the user terminal 300 is first used, a start date and time at which a subsequent chapter (a subsequent content) following after the unread chapter is made available, in association with the subsequent chapter.

Specifically, when a second chapter of a free comic xxx Yaiba Volume 1 (as one example, an e-book indicated by the content ID 231b of “ABC123DEF” and the branch number 231c of “02” in the content management information 231 in FIG. 4) is first used, the setter 242 refers to the content management information 231 and, because the e-book has a subsequent chapter (the branch number 231c of “03”), sets “10/02 21:51” that is a date and time after a lapse of certain time (as one example, twenty-three hours later) in the start date and time 231e associated with the subsequent chapter.

The specifier 243 specifies an unread chapter from among available chapters within another e-book relevant to an e-book (that is, an e-book being used) to which a subsequent chapter with a start date and time set by the above setter 242 belongs.

For example, the specifier 243 specifies an unread chapter available to a user within a free comic (as one example, King xxx Volume 1, xxx Man Volume 1, Tensei xxx Volume 1, . . . ) of the same genre or the same author as that of xxx Yaiba Volume 1 being used.

The estimator 244 estimates required time to be spent when a user uses an unread chapter specified by the above specifier 243.

For example, the estimator 244 estimates required time based on the total number of characters, the total number of frames, the total number of pages, and the like in an unread chapter. Note that, when actual time required for a user to use a similar e-book in the past is measured, the estimator 244 may estimate required time in consideration of the actual time.

The selector 245 selects at least one recommended chapter (a recommended content) according to time remaining until a start date and time set by the setter 242. In other words, the selector 245 selects, as a recommended chapter, an unread chapter specified by the specifier 243.

Specifically, the selector 245 repeats selection of a recommended chapter while specification of an unread chapter by the specifier 243 and estimation of required time by the estimator 244 are continued, until accumulated required time estimated by the estimator 244 becomes equal to or more than remaining time.

The generator 246 generates a recommendation list in which a recommended chapter selected by the above selector 245 is followed by a subsequent chapter.

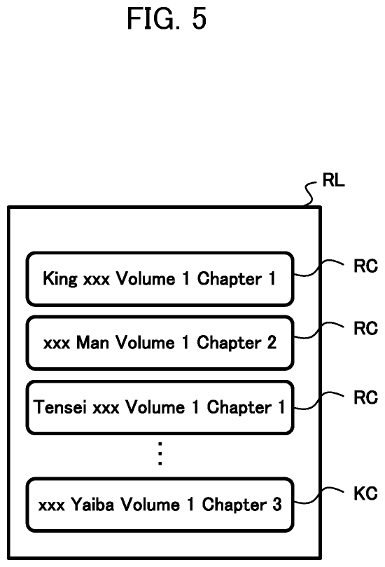

For example, the generator 246 generates a recommendation list RL as illustrated in FIG. 5. In the recommendation list RL, a plurality of candidate chapters RC is followed by a subsequent chapter KC. In this case, when a user uses the candidate chapters RC, a start date and time of the subsequent chapter KC is expected to come and the user can use the subsequent chapter KC as usual.

Returning to FIG. 3, the presenter 247 presents a recommendation list generated by the above generator 246 to the user terminal 300.

In other words, the presenter 247 transmits the recommendation list RL as illustrated in FIG. 5 to the user terminal 300 through the transmitter 220, and causes the user terminal 300 to present the recommendation list RL to a user.

Besides the above, the controller 240 performs payment processing and the like for an e-book purchased by a user, in response to an operation from the user terminal 300.

The above-described CPU 401 or the like may function as the controller 240 including such a configuration.

Function Configuration of User Terminal 300

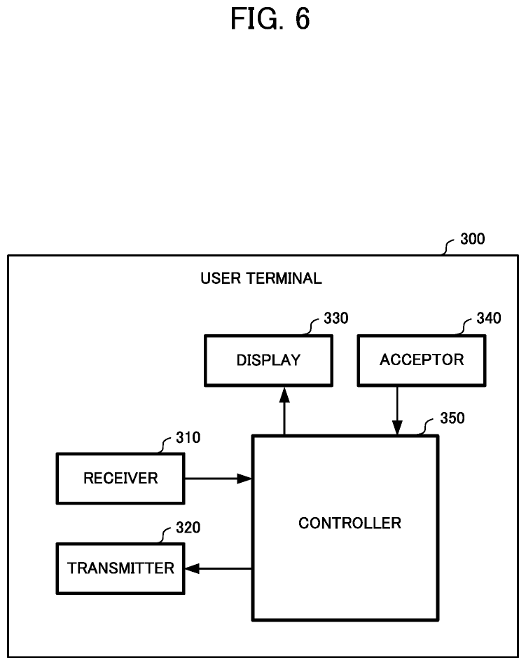

FIG. 6 is a block diagram illustrating one example of a function configuration of the user terminal 300 according to the present embodiment. As illustrated, the user terminal 300 includes a receiver 310, a transmitter 320, a display 330 an, acceptor 340, and a controller 350.

The receiver 310 receives information sent from the content providing device 200 or the like via the internet 900.

For example, the receiver 310 receives actual data of an e-book sent from the content providing device 200. In other words, the receiver 310 receives an e-book made available by purchase or the like. Note that, in a case of an e-book such as a comic provided for free, since the e-book is managed in units of one chapter as described above, the receiver 310 receives an available chapter sent from the content providing device 200.

Further, the receiver 310 receives a recommendation list sent from the content providing device 200.

The above-described NIC 404 may function as the receiver 310 like the above.

The transmitter 320 transmits information toward the content providing device 200 via the internet 900.

For example, the transmitter 320 transmits an instruction to purchase an e-book, an instruction to read an e-book made available, and the like to the content providing device 200.

The above-described NIC 404 may function as the transmitter 320 like the above.

The display 330 displays various types of information to be reported to a user.

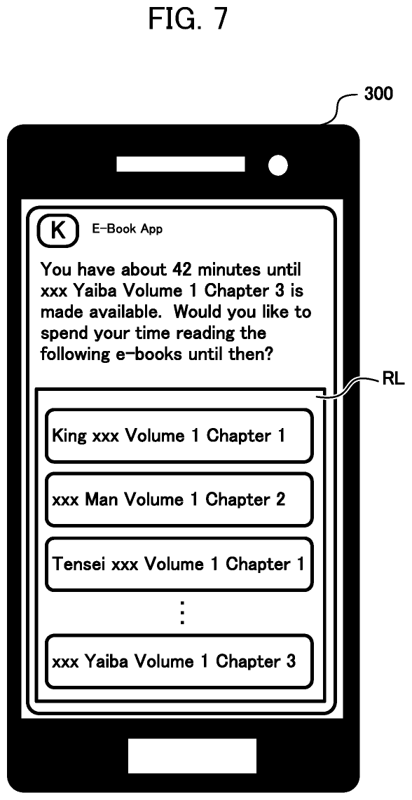

For example, the display 330 displays, according to an instruction to read an available e-book, a content of the e-book. Further, when the above-described receiver 310 receives a recommendation list sent from the content providing device 200, the display 330 displays the recommendation list RL as illustrated in FIG. 7.

The above-described display unit 410 may function as the display 330 like the above.

Returning to FIG. 6, the acceptor 340 accepts an operation from a user.

For example, the acceptor 340 is a touch panel superimposed on the display 330, and accepts a touch operation on a candidate chapter or the like when the recommendation list RL as illustrated in FIG. 7 described above is displayed. When a touch operation on a candidate chapter or the like is performed, a content of a corresponding e-book is displayed on the display 330 and the intended e-book can be read by a user.

The above-described operation unit 409 may function as the acceptor 340 like the above.

The controller 350 controls the entire user terminal 300.

For example, the controller 350 activates, according to an operation of a user, an e-book app to access the content providing device 200, and acquires actual data of an available e-book.

Further, the controller 350 image-processes actual data of an e-book according to a read instruction from a user, and causes the display 330 to display a content of the e-book.

The above-described CPU 401 or the like may function as the controller 350 like the above.

Operation of Content Providing Device 200

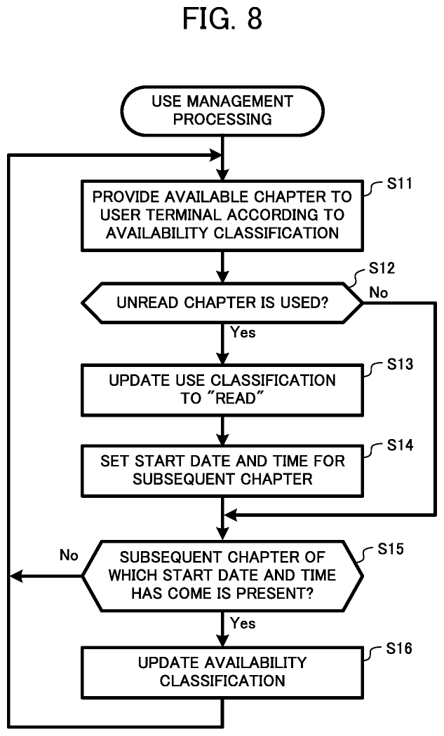

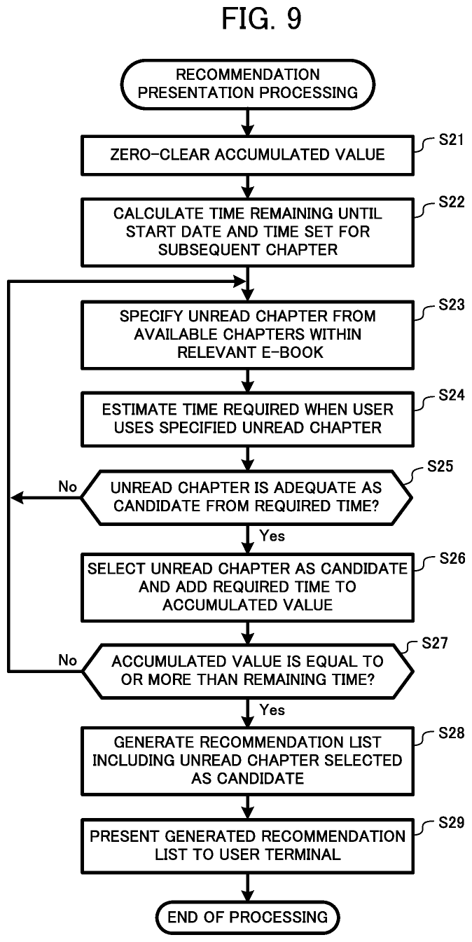

Hereinafter, an operation of the content providing device 200 in the content providing system 100 including such a configuration will be described with reference to FIGS. 8 and 9. FIG. 8 is a flowchart illustrating a flow of use management processing executed by the content providing device 200. FIG. 9 is a flowchart illustrating a flow of recommendation presentation processing executed by the content providing device 200.

First of all, use management processing in FIG. 8 will be described. The use management processing is executed, for example, by the content providing device 200 at any time.

First, the content providing device 200 provides an available chapter to the user terminal 300 according to an availability classification (Step S11).

In other words, the controller 240 (the provider 241) provides, to the user terminal 300, an e-book with the availability classification 231d of 1 (available) in the content management information 231 illustrated in FIG. 4. For example, in a case of an e-book such as a comic provided for free, the controller 240 provides, to the user terminal 300, an available chapter that can be used by a user among chapters within the e-book.

The content providing device 200 determines whether an unread chapter is used (Step S12).

In other words, the controller 240 determines whether an unread chapter not having been used by the user among available chapters provided to the user terminal 300 in Step S11 above is used by the user.

When the content providing device 200 determines that an unread chapter is not used (Step S12; No), the processing proceeds to Step S15 to be described later.

On the other hand, when the content providing device 200 determines that an unread chapter is used (Step S12; Yes), the content providing device 200 updates a use classification to “read” (Step S13).

In other words, the controller 240 updates, in the content management information 231 in FIG. 4, the use classification 231f associated with the used unread chapter from 0 (unread) to 1 (read).

The content providing device 200 sets a start date and time for a subsequent chapter (Step S14).

In other words, the controller 240 (the setter 242) sets, in the content management information 231 in FIG. 4, a date and time after a lapse of certain time (as one example, twenty-three hours later) in the start date and time 231e associated with a subsequent chapter following after the used unread chapter.

The content providing device 200 determines whether a subsequent chapter of which a start date and time has come is present (Step S15).

In other words, the controller 240 determines, in the content management information 231 in FIG. 4, whether a subsequent chapter of which a date and time set in the start date and time 231e has come is present among chapters in the e-book with the availability classification 231d of 0 (unavailable) and with a date and time set in the start date and time 231e.

When the content providing device 200 determines that a subsequent chapter of which a start date and time has come is absent (Step S15; No), the processing returns to Step S11 described above.

On the other hand, when the content providing device 200 determines that a subsequent chapter of which a start date and time has come is present (Step S15; Yes), the content providing device 200 updates the availability classification (Step S16).

In other words, the controller 240 updates, in the content management information 231 in FIG. 4, the availability classification 231d associated with a subsequent chapter of which the start date and time 231e has come from 0 (unavailable) to 1 (available).

Then, the content providing device 200 returns the processing to Step S11 described above. In this case, the e-book (the subsequent chapter) with the updated availability classification is provided to the user terminal 300 in Step S11.

Through such use management processing, an e-book such as a comic provided for free is managed as appropriate in units of one chapter. Then, when a preceding chapter is used by a user, a subsequent chapter is made available to the user after a lapse of certain time.

Next, recommendation presentation processing in FIG. 9 will be described. The recommendation presentation processing is executed, for example, when an e-book (a subsequent chapter) of which a start date and time has not come is attempted to be read by the user terminal 300.

First, the content providing device 200 zero-clears an accumulated value (Step S21).

In other words, the controller 240 sets a default value zero for an accumulated value for accumulation of estimated required time.

The content providing device 200 calculates time remaining until a start date and time set for a subsequent chapter (Step S22).

In other words, the controller 240 calculates, for a subsequent chapter attempted to be read before a start date and time comes, time remaining from a current point in time to the start date and time.

The content providing device 200 specifies an unread chapter from available chapters within a relevant e-book (Step S23).

In other words, the controller 240 (the specifier 243) specifies an unread chapter from among available chapters within another e-book relevant to an e-book (that is, an e-book being used) to which the subsequent chapter belongs.

For example, the controller 240 specifies an unread chapter available to a user within a free comic of the same genre or the same author as that of a free comic being used.

The content providing device 200 estimates time required when the user uses the unread chapter specified in Step S23 above (Step S24).

For example, the controller 240 (the estimator 244) estimates required time based on the total number of characters, the total number of frames, the total number of pages, and the like in the unread chapter. Note that, when actual time required for the user to use a similar e-book in the past is measured, the controller 240 may estimate required time in consideration of the actual time.

The content providing device 200 determines, from the required time estimated in Step S24 above, whether the unread chapter is adequate as a candidate (Step S25).

For example, the controller 240 determines that the unread chapter is not adequate as a candidate when the required time is extremely long or extremely short in relation to the remaining time. Note that, such an approach to determine adequacy is one example, and adequacy of the unread chapter may be determined in another point of view. For example, adequacy of the unread chapter may be determined in relation to an age of the user and a rating of the unread chapter (or a rating of the e-book to which the unread chapter belongs).

When the content providing device 200 determines that the unread chapter is not adequate as a candidate (Step S25; No), the processing returns to Step S23 described above.

On the other hand, when the content providing device 200 determines that the unread chapter is adequate as a candidate (Step S25; Yes), the content providing device 200 selects the unread chapter specified in Step S23 as a candidate, and adds the required time estimated in Step S24 to the accumulated value (Step S26).

In other words, the controller 240 (the selector 245) selects, as a recommended chapter, the unread chapter checked as adequate. Then, the controller 240 adds the required time to the accumulated value for comparison with the remaining time.

The content providing device 200 determines whether the accumulated value becomes equal to or more than the remaining time (Step S27).

When the content providing device 200 determines that the accumulated value is not equal to or more than the remaining time (Step S27; No), the processing returns to Step S23 described above.

On the other hand, when the content providing device 200 determines that the accumulated value is equal to or more than the remaining time (Step S27; Yes), the content providing device 200 generates a recommendation list including the unread chapter selected as a candidate (Step S28).

For example, the controller 240 (the generator 246) generates the recommendation list RL as illustrated in FIG. 5. In the recommendation list RL, the plurality of candidate chapters RC is followed by the subsequent chapter KC. In this case, when the user uses the candidate chapters RC, a start date and time of the subsequent chapter KC is expected to come and the user can use the subsequent chapter KC as usual.

The content providing device 200 presents the recommendation list generated in Step S28 above to the user terminal 300 (Step S29).

For example, the controller 240 (the presenter 247) transmits the recommendation list RL as illustrated in FIG. 5 to the user terminal 300 through the transmitter 220, and causes the user terminal 300 to present the recommendation list RL to the user. In other words, the recommendation list RL as illustrated in FIG. 7 is displayed on the user terminal 300.

Through such recommendation presentation processing, when a subsequent chapter of which a start date and time has not come is attempted to be read, recommended chapters enough to spend time remaining until the subsequent chapter is made available are presented according to the remaining time. Thus, as a user reads the presented recommended chapters, the start date and time comes and the user can read the originally intended subsequent chapter.

As a result, a recommended chapter (a recommended content) can be appropriately selected and presented according to time remaining until a subsequent chapter (a subsequent content) is made available.

### Other Embodiments

In the above embodiment, description has been given to a case where a start date and time set for a subsequent chapter comes as a user uses recommended chapters based on a recommendation list presented to the user terminal 300. However, in fact, a user may read recommended chapters rapidly, and may finish all of the recommended chapters before a start date and time comes.

In such a case, the content providing device 200 may move up a start date and time to make a subsequent chapter immediately available.

For example, when a user uses recommended chapters based on a recommendation list presented to the user terminal 300 and a time difference between a date and time at which the user, even before a start date and time, comes to attempt to use a subsequent chapter and the start date and time is within a reference (as one example, within ten minutes), the provider 241 may update an availability classification of the subsequent chapter to “available” and may provide the subsequent chapter to the user terminal 300.

In this case, an advantage is found in the recommendation list, and use of a recommended chapter based on the recommendation list may be promoted.

Further, in the above embodiment, description has been given to presentation of a recommendation list to the user terminal 300. However, when long time elapses without use based on a recommendation list, the recommendation list cannot be said as appropriate.

In such a case, the content providing device 200 may update a recommendation list.

For example, when a recommendation list is presented to the user terminal 300 and thereafter predetermined time elapses without use of a recommended chapter based on the recommendation list, the selector 245 re-selects a recommended chapter similarly to the above, according to time remaining from a current point in time (the moment in time) to a start date and time.

Further, the generator 246 re-generates a recommendation list in which a recommended chapter re-selected by the selector 245 is followed by a subsequent chapter.

Then, the presenter 247 re-presents a recommendation list re-generated by the generator 246 to the user terminal 300.

In this case, a more appropriate recommendation list can be re-presented to the user terminal 300.

Further, in the above embodiment, description has been given to the content providing system 100 providing e-books as one example. However, the content providing system 100 may provide other contents including, for example, movies and games, without limitation to such e-books.

As one example, the content providing system 100 providing movies manages a serialized drama or animation in units of each episode (or a former part and a latter part within an episode). Similarly, the content providing system 100 providing games manages a game in units of each stage or each chapter of the game.

In other words, the present disclosure is also applicable similarly to the content providing system 100 providing a content set including a plurality of contents to be used (viewed, played, and the like) in defined order, in which, when a preceding content is used, a subsequent content is made available after a lapse of certain time.

As described above, according to the present disclosure, a content providing device, a recommended content presenting method, and a recording medium that can appropriately select and present a recommended content according to time remaining until a content is made available can be provided.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A content providing device comprising:
a storage to store a plurality of content sets including a plurality of contents to be used in defined order, in which, when a preceding content is used, a subsequent content is made available after a lapse of certain time;
a provider to provide, to a user terminal, an available content that is usable by a user among contents within a plurality of the content sets stored in the storage;
a setter to set, when an unused content not having been used by the user among the available contents provided to the user terminal is first used, a start date and time at which a subsequent content following after the unused content is made available, in association with the subsequent content;
a selector to select, according to time remaining until the start date and time set by the setter, at least one recommended content from among the available contents provided to the user terminal;
a generator to generate a recommendation list in which the recommended content selected by the selector is followed by the subsequent content; and
a presenter to present the recommendation list generated by the generator to the user terminal.

2. The content providing device according to claim 1, wherein the provider provides, to the user terminal, the associated subsequent content as the new available content when the start date and time set by the setter comes.

3. The content providing device according to claim 1, further comprising:
a specifier to specify the unused content among the available contents from the another content set relevant to the content set to which the subsequent content belongs,
wherein the selector selects, as the recommended content, the unused content specified by the specifier.

4. The content providing device according to claim 3, further comprising:
an estimator to estimate required time to be spent when the user uses the unused content specified by the specifier,
wherein the selector repeats selection of the recommended content while specification of the unused content by the specifier and estimation of the required time by the estimator are continued, until the accumulated required time estimated by the estimator becomes equal to or more than the remaining time.

5. The content providing device according to claim 1, wherein the provider provides, to the user terminal, the subsequent content as the new available content when the user uses the recommended content in order based on the recommendation list and a time difference between a date and time at which the user, even before the start date and time, comes to use the subsequent content and the start date and time is within a reference.

6. The content providing device according to claim 1, wherein
the selector re-selects, according to the time remaining from a current point in time to the start date and time, the recommended content when predetermined time elapses with the recommended content based on the recommendation list remaining unused by the user after the recommendation list is presented to the user terminal,
the generator re-generates the recommendation list in which the recommended content re-selected by the selector is followed by the subsequent content, and
the presenter re-presents the recommendation list re-generated by the generator to the user terminal.

7. A recommended content presenting method executed by a content providing device that includes a storage for storing a plurality of content sets including a plurality of contents to be used in defined order, in which, when a preceding content is used, a subsequent content is made available after a lapse of certain time, the recommended content presenting method comprising:
providing, to a user terminal, an available content that is usable by a user among contents within a plurality of the content sets stored in the storage;
setting, when an unused content not having been used by the user among the available contents provided to the user terminal is first used, a start date and time at which a subsequent content following after the unused content is made available, in association with the subsequent content;
selecting, according to time remaining until the set start date and time, at least one recommended content from among the available contents provided to the user terminal;
generating a recommendation list in which the selected at least one recommended content is followed by the subsequent content; and
presenting the generated recommendation list to the user terminal.

8. A non-transitory computer-readable recording medium storing a program for causing a computer that includes a storage storing a plurality of content sets including a plurality of contents to be used in defined order, in which, when a preceding content is used, a subsequent content is made available after a lapse of certain time to function as:
a provider to provide, to a user terminal, an available content that is usable by a user among contents within a plurality of the content sets stored in the storage;
a setter to set, when an unused content not having been used by the user among the available contents provided to the user terminal is first used, a start date and time at which a subsequent content following after the unused content is made available, in association with the subsequent content;
a selector to select, according to time remaining until the start date and time set by the setter, at least one recommended content from among the available contents provided to the user terminal;
a generator to generate a recommendation list in which the recommended content selected by the selector is followed by the subsequent content; and
a presenter to present the recommendation list generated by the generator to the user terminal.
